(19) United States
(12) Patent Application Publication
(10) Pub. No.: US 2026/0252540 A1
(43) Pub. Date: Aug. 27, 2026

(54) POLICY-AWARE KNOWLEDGE BASE DEDUPLICATION

(71) Applicant: CIBC, Toronto (CA)

(72) Inventors: Jamal Kawach, Toronto (CA); Maryam Ebrahimi, Toronto (CA); Yijun Li, Toronto (CA)

(21) Appl. No.: 19/648,024

(22) Filed: Apr. 15, 2026

Related U.S. Application Data
(60) Provisional application No. 63/987,180, filed on Feb. 20, 2026.

(51) Int. Cl. G06F 16/215; G06F 16/93

(52) U.S. Cl. CPC G06F 16/215; G06F 16/93

(57) ABSTRACT

Auditable removal of duplicate records from a knowledge base is disclosed. A similarity graph is constructed with documents of the knowledge base as nodes, with similarity edges between the nodes representing inter-document similarity exceeding a similarity threshold. The documents of the similarity graph are clustered by similarity to provide a plurality of clusters within the similarity graph. A set of safeguarded documents of the knowledge base is provided and, for at least one cluster of the plurality of clusters, a representative document is selected, and/or a non-representative, non-safeguarded document is removed from the cluster. A retain set of retained documents and/or a prune set of removed documents may be constructed to improve knowledge base health and output quality of downstream retrieval-augmented generation.

### REFERENCE TO RELATED APPLICATION

This application claims priority from a U.S. provisional patent application No. 63/987,180 entitled “Policy-Aware Knowledge Base Deduplication”, filed on Feb. 20, 2026, and incorporated herein by reference in its entirety.

### TECHNICAL FIELD

The present disclosure relates to knowledge base (KB) management, and specifically to deduplication of large-scale enterprise KBs in regulated environments such as banking, healthcare, government, etc.

### BACKGROUND

Enterprise-level KBs are prone to bloat due to redundant drafts, outdated copies, and near-duplicates, which degrade search/retrieval performance and increase a risk of non-compliance. Deduplication may be used to remove duplicate documents from a KB. However, manual deduplication is labor-intensive and error-prone, while automated deduplication often ignores compliance, policy, or audit requirements. In regulated industries, accidental deletion of a compliance-critical or authoritative documents is unacceptable, making prior-art deduplication systems and methods inefficient and/or non-scalable.

### BRIEF DESCRIPTION OF THE DRAWINGS

Exemplary embodiments will now be described in conjunction with the drawings, in which:

FIG. 1 is a schematic diagram of a system for policy-aware knowledge base deduplication in accordance with this disclosure;

FIG. 2 is a flow chart of a method for policy-aware knowledge base deduplication of this disclosure;

FIG. 3 is a schematic diagram of an example computing system suitable to implement the system and method of FIGS. 1 and 2; and

FIG. 4 is a schematic diagram of an example networking suitable to implement the system and method of FIGS. 1 and 2.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering but rather are intended to distinguish one element from another, unless explicitly stated. Similarly, sequential ordering of method steps does not imply a sequential order of their execution, unless explicitly stated. The term “module” is taken to mean a hardware and/or functional module.

In regulated industries such as banking, government, healthcare, etc., accuracy and reliability of internal information retrieval are critical. Employees may rely on artificial intelligence (AI) powered chatbots to search for and access internally-stored procedures, including information on daily enterprise operations, servicing, card management, and daily client interaction scripts. The underlying knowledge base for such systems must be both comprehensive and authoritative.

Large-scale enterprise knowledge bases may suffer from unmanaged growth as a result of accumulation of redundant copies and obsolete procedures that bloat the search index. Without a unified lifecycle framework, content is frequently copy-pasted, leading to small syntactic or semantic variants of the same procedure proliferating across different teams and areas of service or production. Outdated pages persist alongside new versions, creating semantic near-duplicates that often obscure retrieval context. This “knowledge base bloat” not only increases data storage requirement and retrieval latency but also degrades the quality of generated answers by retrieving conflicting or obsolete information via retrieval-augmented generation. Existing KB cleaning/deduplication approaches can pose a problem in high-stakes environments because they do not account for the various policies or regulatory requirements that may exist within the enterprise.

The present disclosure provides an automated cleaning/deduplication mechanism which is flexible enough to detect semantic near-duplicate documents, hence successfully reducing bloat while protecting the immutability of critical documents and/or safeguarded documents and meeting requirements of policy-aware enterprise knowledge base deduplication.

A computer-implemented method of this disclosure for knowledge base deduplication includes providing a similarity graph where documents of a knowledge base D are nodes of the graph. Edges of the graph represent a level of similarity between the nodes (i.e. the documents of the knowledge base) exceeding a threshold, indicating a strong similarity between the nodes. The threshold may be pre-defined or generated dynamically. The documents are clustered within the graph by similarity. A plurality of clusters is thereby provided within the similarity graph, each cluster representing a group of semantically similar documents.

The method may further include providing a set of safeguarded documents of the knowledge base. These may be, for example, policy-related documents and/or documents with a safeguard flag. The importance of documents may also be determined dynamically. In some embodiments, the safeguarded documents set is provided based on at least one of: a direct designation by a subject matter expert (SME) or a machine learning (ML) model; document metadata; a policy; or a document rank.

For each cluster of the similarity graph, one or more representative documents may be selected. The non-representative, non-safeguarded document(s) may then be removed/pruned. The similarity between documents u and v of the knowledge base D may be determined based on cosine similarity between vector-embedded representations xᵤ and xᵥ of the documents u and v, word n-gram shingling and a Jaccard index determined from n-gram shingles of the documents u and v, and other suitable means. Where multiple similarity criteria are used, the overall blended similarity may be determined by specifying a blending parameter. By way of a non-limiting illustrative example, where cosine similarity and Jaccard index are used to establish document similarity, the blending may be based on a weighted sum of the cosine similarity and the Jaccard index. The representative document may be selected by a greedy dominating-set process. The greedy dominating-set process may be seeded with the set of safeguarded documents thus automatically ensuring that the safeguarded documents will not be deleted.

In some embodiments, the similarity graph further includes reference edges between documents u and v of the knowledge base D representing a direct reference from the document u to the document v. The selecting and/or removing process may be configured to take into account the reference edges within the corresponding cluster.

After each similarity cluster has been processed in the manner described above, a retain set R of retained documents and/or a prune set P of removed documents may be formed. The retain sets R of the clusters may be combined into an active documents index. The prune sets P of the clusters may be combined into a pruned documents index. A record of a removal of each document from the knowledge base D may be made in such a manner that the removal is auditable.

A system may be provided comprising at least one processor configured to implement the above described method. A computer-readable medium may be provided storing instructions which, when executed by a processor, cause the processor to perform the above described method.

The system represents an improved computer system for operating and maintaining a knowledge base. The demonstrated improvement includes safeguarding important documents during knowledge base cleaning/deduplication, auditable removal of any pruned document for regulatory compliance, and improved knowledge retention and retrieval quality. When configured in a way disclosed herein, or in a similar way, the knowledge base operating/maintaining/pruning system of this disclosure becomes usable in regulated environments such as banking, healthcare, government, and other environments. The memory usage of such computer system may be improved by the knowledge base pruning because the pruned knowledge base requires less memory for storage. This is a tangible, substantial, and physical result of using systems and methods of this disclosure. Furthermore, the pruned knowledge base has been demonstrated to provide higher quality retrieval output, and has shown better reliability in retrieving the most relevant document when given a user query.

In accordance with this disclosure, there is provided a computer-implemented method for knowledge base deduplication. The method includes providing a similarity graph having documents of a knowledge base D as nodes, with similarity edges between the nodes representing inter-document similarity exceeding a similarity threshold. The documents are clustered by document-to-document similarity to provide a plurality of clusters within the similarity graph. A set of safeguarded documents of the knowledge base is provided. For at least one cluster of the plurality of clusters, a representative document is selected, and/or a non-representative, non-safeguarded document is removed from the cluster.

In some embodiments, the similarity between documents u and v of the knowledge base D may be determined based on a cosine similarity between vector-embedded representations xᵤ and xᵥ of the documents u and v respectively. The similarity between the documents u and v may be further determined based on word n-gram shingling and a Jaccard index determined from n-gram shingles of the documents u and v. For example, the similarity between the documents u and v may be determined based on a weighted sum of the cosine similarity and the Jaccard index.

The safeguard documents set may be provided based on at least one of the following: a designation by a subject matter expert, a designation by a machine learning model, document metadata, a policy, a document rank, and the like. The representative document may be selected by a greedy dominating-set process, which may be seeded with the set of safeguarded documents. This makes sure that the safeguarded documents are not deleted.

In embodiments where the similarity graph further includes reference edges between documents u and v of the knowledge base D representing a direct reference from the document u to the document v, the selecting and/or removing may take into account such reference edges within the corresponding cluster. The method of this disclosure may further include providing, for each cluster of the similarity graph, at least one of a retain set R of retained documents or a prune set P of removed documents. The retain sets R may be combined into an active documents index, and/or the prune sets P may be combined into a pruned documents index. A record may be made of a removal of each document from the knowledge base D in an auditable manner.

In accordance with the present disclosure, there is provided a computer-readable medium storing instructions which, when executed by a processor, cause the processor to perform an embodiment of the above method.

In accordance with the present disclosure, there is further provided a computer-implemented system for knowledge base deduplication. The system includes a graph construction module for providing a similarity graph having documents of a knowledge base D as nodes, with similarity edges between the nodes representing inter-document similarity exceeding a similarity threshold, and for clustering the documents by document-to-document similarity to provide a plurality of clusters within the similarity graph. A safeguard set store provides a set of safeguarded documents of the knowledge base. A similarity cluster formation module operates on a cluster of the plurality of clusters by at least one of selecting a representative document or removing a non-representative, non-safeguarded document from the cluster.

The similarity cluster formation module may include a semantic similarity clustering module for determining the similarity between documents u and v of the knowledge base D based on a cosine similarity between vector-embedded representations xᵤ and xᵥ of the documents u and v respectively. The similarity cluster formation module may be further configured to determine the similarity between the documents u and v based on word n-gram shingling and a Jaccard index determined from n-gram shingles of the documents u and v. The similarity cluster formation module may be further configured to determine the similarity between the documents u and v based on a weighted sum of the cosine similarity and the Jaccard index. The similarity cluster formation module may include a pruning module configured for running a greedy dominating-set process seeded with the set of safeguarded documents for removing the non-representative, non-safeguarded document from the cluster.

The safeguarded documents set may be provided by the safeguard set store based on at least one of: a designation by a subject matter expert; a designation by a machine learning model; document metadata; a policy; or a document rank. The similarity graph may further include reference edges between documents u and v of the knowledge base D representing a direct reference from the document u to the document v. The similarity cluster formation module, when performing the at least one of selecting or removing, may be configured to take into account the reference edges within the corresponding cluster.

The system may further include an aggregation module for providing, for each cluster of the similarity graph, at least one of: a retain set R of retained documents; or a prune set P of removed documents. The aggregation module may be configured for at least one of: combining the retain sets R of the clusters into an active documents index; or combining the prune sets P of the clusters into a pruned documents index. The system may be configured to provide a record of a removal of each document from the knowledge base D in an auditable manner.

### Definitions

Safeguard Set: User-defined set of documents that must be preserved regardless of redundancy. This can also incorporate graph-based (or other related) signals, such as centrality or importance of a document, which may be computed algorithmically. In other words, these signals can be combined with the user-defined set of documents.

Seeded greedy dominating-set: Process that selects representatives in a cluster, starting from safeguarded nodes.

Chunk-level uniqueness: Scoring of unique content at sub-document granularity.

Retention Set: Documents retained after deduplication.

Audit trail: Record of all pruning decisions and rationale.

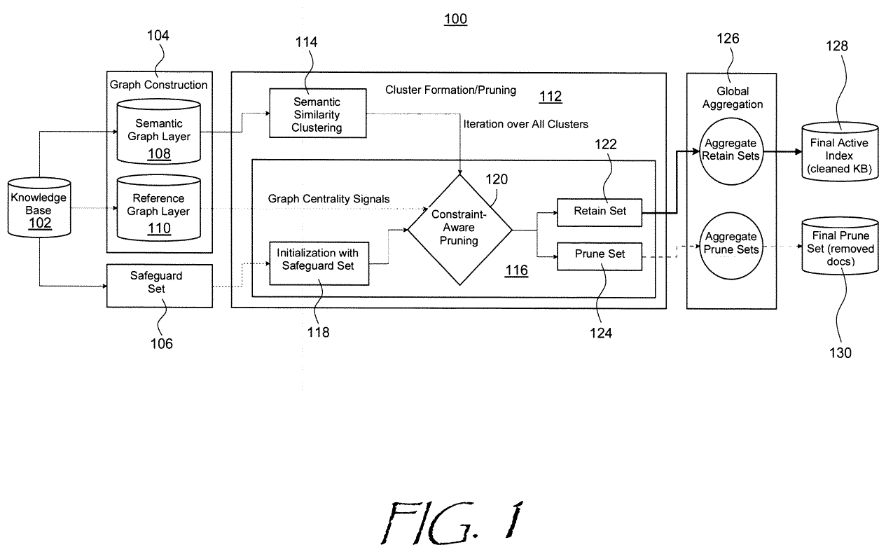

Referring to FIG. 1, a system 100 of this disclosure includes a knowledge base store 102 for storing documents of a knowledge base D. The knowledge base D may include multiple revisions of a same document, duplicates, etc., which need to be deleted or pruned in a responsible and auditable manner to improve the retrieval quality and/or reduce errors. The knowledge base store 102 is coupled to a global graph construction module 104 and a safeguard set store 106. The global graph construction module 104 constructs a graph from documents stored in the knowledge base store 102. The graph may include a semantic graph layer 108 and/or a reference graph layer 110. The semantic graph layer 108 stores a graph having nodes as documents of the knowledge base store 102 and edges representing semantic similarity of the corresponding node documents. This will be explained further below. The reference graph layer 110 stores a graph having nodes as documents of the knowledge base store 102 and edges representing references or links from one node document to another. The safeguard set store 106 stores documents, links, and/or identification of the documents that are to be safeguarded from deduplication/pruning.

A similarity cluster formation module 112 includes a semantic similarity clustering module 114 coupled to a pruning module 116. The function of the semantic similarity clustering module 114 is to build a semantic similarity graph from documents Dᵢ of the knowledge base D where the documents Dᵢ represent nodes of the similarity graph, and similarity edges between the documents represent inter-document similarity exceeding a similarity threshold parameter. The similarity threshold parameter may be pre-set or dynamically adjusted. The function of the pruning module 116 is to remove nodes within the similarity clusters Cᵢ of the similarity graph representing duplicate documents. To that end, the pruning module 116 may include a content remover 120 and an initializer 118 for initializing the content remover 120 with a safeguard set S of safeguarded documents.

The content remover 120 is configured to separate the documents into a retain set R 122 of retained documents Ri and a prune set P 124 of removed or pruned documents Pᵢ. For this, the content remover 120 may employ constraint-aware greedy pruning seeded with the safeguard set S. An example of such constraint-aware greedy pruning will be provided further below. The content remover 120 may use the reference graph layer 110 for determination of graph centrality metrics of the similarity graph. More generally, any graph- or network-based metric which leverages the reference graph may be used to provide signals when removing content from the knowledge base D.

The system 100 may further include a global aggregation module 126 whose function is to aggregate the individual retention sets R 122 of retained documents Rᵢ, and/or to aggregate the individual prune sets P 124 of removed or pruned documents Pᵢ, from all similarity clusters of the similarity graph. The individual retention sets R may be stored as a final active index 128 of a cleaned knowledge base, and the individual prune sets P may be stored as a final pruned set 130 of documents removed from the knowledge base D.

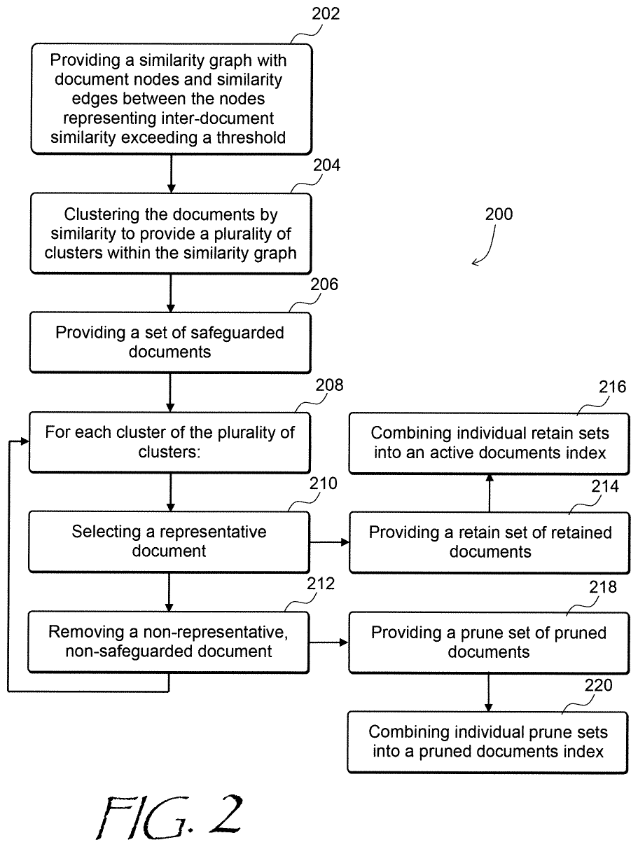

Turning to FIG. 2 with further reference to FIG. 1, a computer-implemented method 200 for policy-aware knowledge base deduplication may include providing (202) a similarity graph having documents of a knowledge base D as nodes, with similarity edges between the nodes representing inter-document similarity exceeding a similarity threshold. For example, the similarity graph may be constructed by the graph construction module 104 of FIG. 1 and stored in the semantic graph layer 108 of the graph construction module 104.

The method 200 of FIG. 2 may further include clustering (204) the documents by similarity between the documents to provide a plurality of clusters within the similarity graph. The clustering means that the entire graph is split into groups of documents related to one another by similarity, e.g. the semantic similarity, exceeding the similarity threshold. Documents within the group or “similarity cluster” may be processed together, in a sense that representative document(s) and/or the document(s) subject to pruning or removal, if any, are identified within each group and are processed group-by-group.

A set of safeguarded documents of the knowledge base D, e.g. the safeguard set store 106 of the knowledge base of FIG. 1, is provided (FIG. 2; 206). The safeguarded documents are those not to be deleted by the pruning process. The “do not delete” status may be represented by a corresponding flag, identifier, reference, list, etc., and may be provided or set by an expert human. In some cases, the corresponding flag, identifier, reference, or list may be generated automatically. The safeguarded documents set may be provided based on e.g. a designation by a subject matter expert, a designation by a machine learning model, document metadata, a policy, a document rank, etc.

The pruning process may be initiated for at least one cluster and, in some embodiments, one-by-one for each cluster (208). In general terms, the pruning may include selecting (210) a representative document and/or removing (212) a non-representative, non-safeguarded document from the cluster being processed. For each cluster of the similarity graph, the retain set R (FIG. 1; 122) of retained documents may be provided (FIG. 2; 214); and/or the prune set P (FIG. 1; 124) of removed documents may be provided (FIG. 2; 218). The retain sets of individual similarity clusters may be combined (216) into an active, i.e. retained, documents index. The prune sets of individual similarity clusters may be combined (220) into a pruned, i.e. deleted, documents index.

The global aggregation module (FIG. 1; 126) aggregates the individual retention sets R 122 of retained documents Rᵢ and/or the individual prune sets P 124 of removed or pruned documents Pᵢ for all similarity clusters of the similarity graph. A record of removal of each document from the knowledge base D may be made in an auditable manner, e.g. by keeping a log of similarity scores in each similarity cluster, and/or by keeping a record of justification of each removal. In some embodiments, the similarity between documents u and v of the knowledge base D is determined based on at least one of 1) a cosine similarity between vector-embedded representations xᵤ and xᵥ of the documents u and v respectively; or 2) word n-gram shingling and a Jaccard index determined from n-gram shingles of the documents u and v. The similarity between the documents u and v may be determined based on a weighted sum of the cosine similarity and the Jaccard index.

A specific non-limiting illustrative example of operation of the system 100 of FIG. 1 using the method 200 of FIG. 2, including similarity determination mentioned above, will now be provided. In this example, the system 100 selects a subset of documents (the retention set, R) from the full knowledge base D to maximize information coverage while minimizing redundancy, under the constraint that a mandatory safeguard set S⊆D is strictly preserved.

### Clustering (Actions 202 and 204 Performed by Semantic Similarity Clustering Module 114)

The redundancy in the corpus D may be modeled with using a two-layer document graph (V, Eₛᵢₘ, E_{ref}) as follows:

Nodes (V): Each node corresponds to a document from D.

Similarity edges (Eₛᵢₘ): A similarity edge exists between two documents u and v if their similarity exceeds a fixed similarity threshold τₛᵢₘ, for a fixed similarity function such as, for example, cosine similarity between vector-embedded representations of the documents in the corpus D.

Reference edges (E_{ref}): A reference edge exist from document u to v if there is a direct reference from u to v, e.g., in the form of a hyperlink.

The semantic graph layer (V, Eₛᵢₘ) typically consists of many disjoint subgraphs, each representing a repeatable procedure or process (e.g., a cluster of ten versions of a “Wire Transfer Procedure”) with potential redundancy, e.g., slight regional differences or a minor variation in a particular step in a process. For the rest of this section, a set of clusters C={C₁, . . . , Cₖ} obtained by taking connected components of (V, Eₛᵢₘ) is fixed. The reference graph layer (V, E_{ref}) is not used for clustering, but can be invoked to aid the pruning process and to help measure knowledge base health.

### Safeguard Set (Action 206; Safeguard Set Store 106)

The constraints or policies are injected via a fixed, user-defined safeguard set S D, which enumerates documents that must be preserved regardless of redundancy, according to a boolean BusinessRule flag. The predicate defining S can incorporate curated tags, graph-structural signals (e.g., centrality), or traffic/usage metrics. In general,

$$S := \{ d ∈ D : BusinessRule ( d ) = True \} \qquad ( 1 )$$

During the pruning process, documents in S may act as immutable seeds that must be retained. In this example, S consists of subject matter expert-labelled documents which are to be preserved even if near-duplicates exist.

### Similarity Modeling (Action 202 Performed by Semantic Similarity Clustering Module 114)

Within each cluster, a symmetric, dense similarity matrix may be constructed that blends semantic similarity of embeddings with lexical overlap on word n-grams. This blended similarity drives the coverage relation for the dominating set selection.

Cosine similarity (clipped): Let xᵤ, xᵥ∈R_{d} be document embeddings corresponding to documents u, v∈D, which are assumed here to have been pre-computed. The cosine similarity is

$$CosSim ( u , v ) = \frac{{x}_{u}^{T} {x}_{v}}{‖ {x}_{u} ‖ ‖ {x}_{v} ‖} \qquad ( 2 )$$

Because cosine similarity can be negative, one can clip it to [0, 1] to align scales with set-based similarities:

$$CosClip ( u , v ) := max ( 0 , CosSim ( u , v ) ) \qquad ( 3 )$$

Word n-gram shingling and Jaccard similarity: In addition to cosine similarity, one can also leverage a syntactic measure of similarity between texts via the Jaccard index. For a document u, one can form the set of contiguous word n-grams (“shingles”) by tokenizing to lowercase word tokens and then sliding a window of size n:

$$S n ( u ) = \{ {w}_{i} {w}_{i + 1} … {w}_{i + n - 1} : 1 \leq i \leq \vert u \vert - n + 1 \} \qquad ( 4 )$$

Given two non-empty documents u and v, the Jaccard similarity on word n-gram sets is

$${Jaccard}_{n} ( u , v ) = \frac{{S}_{n} ( u ) ⋂ {S}_{n} ( v )}{{S}_{n} ( u ) ⋃ {S}_{n} ( v )} \qquad ( 5 )$$

It is noted that Sₙ(⋅) and Jaccardₙ(⋅, ⋅) may be computed on-the-fly, restricted to pairs within the same cluster.

Blended similarity: One can combine clipped cosine and Jaccard via a convex blend with parameter a € [0, 1]:

$$S i {m}_{b l e n d}^{( n , a )} ( u , v ) := ( 1 - α ) CosClip ( u , v ) + {αJaccard}_{n} ( u , v ) \qquad ( 6 )$$

This yields a similarity in the range of [0, 1] that captures both semantic proximity (embeddings) and lexical overlap (shingles).

### Constraint-First Pruning Via Seeded Greedy Dominating Set (Action 212 Performed by the Content Remover 120)

For each similarity cluster Cᵢ, one can compute a retention set Rᵢ⊆Cᵢ of representative documents and a pruning set Pᵢ⊆Cᵢ of documents flagged as near-duplicates of retained representatives. S denotes a fixed safeguard set of documents that must be preserved.

Coverage relation: In a fixed a coverage threshold τ_{cov}∈(0, 1), for documents u, v∈Cᵢ, one can define

$$u covers v ⇐ ⇒ Si {m}_{b l e n d}^{( n , a )} ( u , v ) \geq {τ}_{c o v} \qquad ( 7 )$$

The coverage is reflexive and symmetric. Next, for u∈Cᵢ, one can define its cluster-restricted coverage neighborhood as

$${N}_{c o v} ( u ) := \{ v ∈ {C}_{i} : {Sim}_{b l e n d}^{( n , a )} ( u , v ) \geq {τ}_{c o v} \} \qquad ( 8 )$$

Seeded Greedy Selection (Cluster-wise): For each cluster Cᵢ∈C, the selection process constructs (Rᵢ, Pᵢ) as follows:
(1) Initialization (safeguard seeding): One can start by setting Rᵢ:=Cᵢ∩S and Pᵢ:=Ø. All non-safeguarded documents covered by the seeded representatives are immediately flagged for pruning:

$${P}_{i} := {⋃}_{u ∈ Ri} ( {N}_{c o v} ( u ) ∖ {R}_{i} ) \qquad ( 9 )$$

The set of currently unassigned documents may be defined as

$${U}_{i} := {C}_{i} ∖ ( {R}_{i} ⋃ {P}_{i} ) ( 2 ) Greedy iteration : While {U}_{i} \neq ∅ : \qquad ( 10 )$$

(i) Choose a representative u*∈Uᵢ that maximizes new coverage within the unassigned set:

$${u}^{*} := arg {max}_{u ∈ Ui} \vert {N}_{c o v} ( u ) ⋂ {U}_{i} \vert \qquad ( 11 )$$

(ii) Tiebreaking (optional): If the maximizer is not unique, break ties using available metadata (e.g., PageRank, in-degree restricted to Cᵢ) in descending order; otherwise choose an arbitrary maximizer.
(iii) Add the chosen u* to the retention set: Rᵢ: =Rᵢ∪{u*}.
(iv) Flag all newly covered remaining documents (excluding u*) for pruning:

$${P}_{i} := {P}_{i} ⋃ ( ( {N}_{c o v} ( {u}^{*} ) ⋂ {U}_{i} ) ∖ \{ {u}^{*} \} ) \qquad ( 12 )$$

(v) Update the unassigned set: Uᵢ:=Cᵢ\(Rᵢ∪Pᵢ).

After processing all clusters, the global retention and pruning sets are

$$R := {⋃}_{{C}_{i} ∈ C} {R}_{i} ; P := {⋃}_{{C}_{i} ∈ C} {P}_{i} \qquad ( 13 )$$

Documents in P are flagged as near-duplicates for removal, while documents in R are retained.

Traceability: For every pruned document v∈Pᵢ, one can record a witness (or covering representative) w(v)∈Rᵢ such that w (v) covers v (i.e., v∈Nτ (w(v))). This witness is assigned at the moment v is added to Pᵢ (either during safeguard seeding or a greedy step), and is exported alongside the pruning flag in the final output. This enables post-hoc auditing of pruning decisions and supports explainability.

Singleton Handling: One may note that documents assigned to a cluster of size 1 (singletons) are always preserved by the above approach, since Rᵢ=Cᵢ when |Cᵢ|=1. Such documents can be specially handled via a simple, optional module which can be run independently from the greedy process outlined above. To measure only the effect of cluster-driven deduplication, one may avoid use of specialized singleton flagging and focus only on documents with near-duplicates. By default, this means all singletons are preserved.

The above described system and method for knowledge base pruning and maintenance improve retrieval performance and knowledge base health, as measured by retrieval and knowledge base health metrics. The pruning process of this disclosure utilizes efficient parametrization for operational tuning and compliance adaptation, and allows knowledge retention and retrieval quality to be measured. The process also provides an audit trail with full explainability of pruning decisions. Chunk-level uniqueness scoring allows one to properly account for documents similar in content but unique in their application (e.g. regional variations of a same document). Methods of this disclosure allow integration with audit trails, dashboards, or compliance workflows.

In some embodiments, the safeguard set may be inferred automatically using metadata, document usage, or machine learning. The deduplication may be cross-modal (e.g. spanning across text, email, structured data, etc.). Human-in-the-loop approach may be used for high-risk removals. Access controls, retention schedules, and explainability features may be provided in some embodiments. The pruning may be performed in real time. It is to be noted that a main purpose for measuring chunk-level uniqueness is to address a case where a document appears to be redundant (on the level of the entire document) but contains a unique subsection not appearing elsewhere in the knowledge base. In such a case, the document is at risk of being flagged for removal, meaning that the unique subsection would be lost upon pruning. The chunk-level uniqueness measurement allows one to mitigate such risk.

Listed below are non-limiting examples of implementation and variants of a system and/or method of this disclosure.

### A. Explicit Data Schemas and Pseudocode for all Data Structures

1. A document table that stores canonical text representation of each knowledge base document (typically extracted/cleaned from source formats such as HTML or PDF) along with associated metadata. The document table may be loaded from Excel (or .csv) into a row-indexed table/DataFrame, where each row corresponds to a single document and the row index serves as the internal identifier used across the pipeline. Key fields may include a stable external identifier, a text field used for text-based similarity, and optional safeguards such as a Boolean flag to prevent removal during pruning. All fields are typically in string or numerical format.
2. Embedding representations generated from the parsed/cleaned document text and stored as a NumPy matrix of shape (N_docs, D), where N_docs is the number of documents in the knowledge base and each row is the embedding vector for one document and D is the embedding dimension determined by the embedding model. The embeddings may be stored as a list of float32 (FP32) values, but precision can be adjusted.
3. n-gram shingles may be generated from each document's text: each document may be mapped to a set of word n-grams, i.e., continuous patches of words of length n (with n adjustable). These shingle sets may be computed as sets of strings, and may be constructed on-the-fly per cluster (or cached) rather than stored as a single large global table.
4. Graph construction and storage may be performed by thresholding document-to-document similarity to produce a graph in which nodes are documents and edges indicate similarity above a chosen threshold. Numerical edge weights may store the similarity score. Reference edges (e.g., to capture hyperlinks) may also be constructed. In-memory, this graph can be represented as a multigraph using e.g. the NetworkX Python library, and optionally persisted as a simple edge list (e.g., list of (document I, document II, similarity score) tuples). For very large knowledge bases, NetworkX may not scale well; in this case a graph database such as Neo4j can be used when interactive graph querying is required, though it is not strictly necessary for offline connected-components clustering.
5. Clusters may be represented as connected components of the similarity graph computed via the NetworkX library. Each cluster may then be stored as a list of document IDs that belong to the same component. Each cluster may be assigned a string identifier.
6. The final pruning output may be stored as a machine-readable list of documents to remove, usually in the form of a list of numerical document indices flagged for removal. This output is designed to be directly applied to filter the document table. This output can also augment the original input document table, by adding a new “flagged” column, which indicates whether a document is flagged or not.

### B. Operational Details for Dynamic Safeguard Set Updates

One approach to implementing dynamic safeguard set updates is to provide a separate step in the pipeline where the initial safeguard set can be augmented iteratively, guided by a human. For example, once the graph construction step is completed and the user is presented with a list of clusters, one may compute centrality or usage-based metrics and present candidate documents to add to the existing safeguard set. However, each such candidate would likely need to be verified by a human.

### C. Functional Module and Method Step Variants/Alternatives

Alternative authority metrics could include any sort of network centrality/importance measure, including, but not limited to, PageRank and its variations (such as a “personalized” or “weighted” version, which incorporates metadata such as the number of times a document has been accessed), document hub/authority scores, page views, or node degree (i.e., the number of connections corresponding to a node).

Alternative set cover heuristics could include replacing the similarity metric and/or threshold used in the definition of “coverage”, or the use of a more complex method beyond the above-described greedy process, such as a genetic process to compute a dominating set within each cluster.

Alternative similarity metrics could include any type of metric for comparison of vector embeddings (such as variants of Euclidean distance, e.g., Manhattan distance); for comparison of collections of words, metrics such as the Dice coefficient or edit distance can be used in place of Jaccard similarity. A combination of any of the above vector embedding+word metrics could be used to form a blended similarity measure. The specific selection depends on the particular knowledge base or use case, but it is feasible to conduct a “sweep” over the various choices of similarity/authority metrics and thresholds to find the best performing combination.

### D. Format and Structure of Audit Logs

The audit log produced by a system and/or method of this disclosure may be e.g. in the form of a .csv or Excel file. The audit log may record e.g. all original document metadata (e.g., ID, document title, contents), the cluster ID of the document (computed during the graph construction and clustering step), and a binary removal flag. For documents which are flagged for removal, an additional field may be provided which displays the ID of the preserved document which was responsible for “covering” the removed document. Users can access the logs after the entire pipeline has been completed. The users can then analyze the list of documents that were flagged for removal and verify whether or not they should be removed from the knowledge base.

### E. Operational Requirements

Since the pipeline may be run entirely offline only producing a list of documents which were flagged for removal, it may be assumed that the user running the pipeline has the appropriate privileges to view the original documents. Hardware requirements depend on the size of the knowledge base, but a minimum of 8 GB of RAM to run similarity computations plus a modern processor (e.g., Intel Core i5, or AMD Ryzen 5) to meet minimum CPU requirements for generating embedding vectors would be beneficial. At least 1 GB storage may be needed to store all documents and embedding vectors for a reasonably-sized knowledge base. Minimum software requirements may be Windows 10/11 and Python 3.8+. A system of this disclosure may be run on cloud or on premises, as long as the above resources are available.

Embodiments of this disclosure may be implemented in a computer-readable medium storing instructions which, when executed by a processor, cause the processor to perform the method 200 of FIG. 2 for knowledge base deduplication.

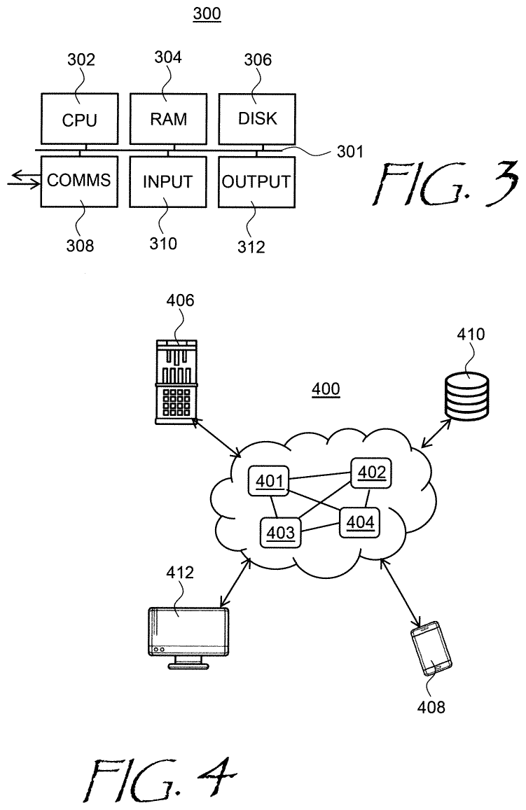

Embodiments of this disclosure may be implemented in a computing system. Referring to FIG. 3 for a non-limiting illustrative example, a computing system 300 may be configured to implement the system 100 of FIG. 1, the method 200 of FIG. 2, as well as other systems and methods disclosed herein. The computing system 300 may include at least one computer processor (CPU) 302, non-persistent storage 304 e.g. random access memory (RAM), cache memory, etc., persistent storage 306 such as flash memory, a hard drive (DISK), an optical drive such as a compact disk (CD) drive or a digital versatile disk (DVD) drive, etc. The computer processor 302 may include integrated circuitry for processing instructions, which may be stored on the non-persistent 304 or persistent 306 storage. The computer processor 302 may include one or more cores, mini-cores, or micro-cores.

The computing system 300 may further include a communication interface 308 (COMMS) such as wireless interface, infrared interface, network interface, optical interface, etc., and other elements and functionalities. At least one input device 310 (INPUT) such as a keyboard, a mouse, a touchscreen, a touchpad, a microphone, an electronic pen, or any other type of input device, may be provided. The communication interface 308 may include an integrated circuit for connecting the computing system 300 to a network e.g. a local area network (LAN), a wide area network (WAN) such as the Internet, a mobile network, or any other type of network) and/or to another device, such as a computer, a smartphone, etc.

The computing system 300 may further include at least one output device 312 (OUTPUT) such as a monitor screen e.g., a liquid crystal display (LCD), a plasma display, a touchscreen, a cathode ray tube (CRT) monitor, a projector or another display device, a printer, an external storage, or any other output device as the case may be. The computer processor 302, the non-persistent storage 304, the persistent storage 306, the communication interface 308, the input device 310, and the output device 312 may communicate with one another via a dedicated bus 301. In some embodiments, the input 310 and output 312 devices may be remotely connected to the computer processor 302, the non-persistent storage 304, and/or the persistent storage 306. Many different types of computing systems, architectures, input/output devices, and communication configurations may be used in embodiments of this disclosure.

Software instructions in form of computer readable program code to perform embodiments of this disclosure may be stored, in whole or in part, temporarily or permanently, on a non-transitory computer readable medium of the persistent storage 306 such as flash memory, a CD, a DVD, a storage device, a diskette, a tape, physical memory, or any other suitable computer readable storage medium. The software instructions may correspond to computer readable program code that, when executed by the computer processor 302, is configured to perform one or more functions disclosed herein.

The computing system 300 of FIG. 3 may be connected to or be a part of a network. Referring to FIG. 4 for a non-limiting illustrative example, a network 400 may include multiple nodes, e.g. first 401, second 402, third 403 and fourth 404 nodes. More or less nodes may be provided. Each node 401-404 may be based on a computing system such as the computing system 300 of FIG. 3 described above. By way of a non-limiting illustrative example, embodiments of this disclosure may be implemented on a node of a distributed system that is connected to other nodes. By way of another non-limiting illustrative example, embodiments of this disclosure may be implemented on a distributed computing system having multiple nodes, where each portion of the computing system may be located on a different node. Furthermore, one or more elements of the aforementioned computing system may be located at a remote location and connected to the other elements over a network. The nodes 401-404 of the network 400 may be configured to provide services disclosed herein to clients via client devices such as a user's computer 406 or a user's mobile device 408.

The nodes 401-404 may be part of a cloud computing system. The nodes 401-404 may include functionality to receive requests from the client device and transmit responses to the client device. The client device may include a computing system such as the computing system 300 of FIG. 3 and, in some cases, may perform all or a portion of one or more embodiments disclosed herein. The network 400 of FIG. 4 may further include other service-specific devices and systems, such as a data repository 410, an information display or dashboard 412, etc.

Although not shown in FIG. 4, at least some of the nodes 401-404 may correspond to a blade in a server chassis connected to other one(s) of the nodes 401-404 via a backplane. By way of a non-limiting example, the node(s) may correspond to a server in a data center. By way of another non-limiting example, the node(s) may correspond to a computer processor or micro-core of a computer processor with shared memory and/or resources.

The computing system 300 of FIG. 3 or the group of computing systems or nodes 401-404 of the network 400 of FIG. 4 may include functionality to perform a variety of operations, procedures, and/or methods disclosed herein. By way of a non-limiting illustrative example, the computing system(s) disclosed herein may perform communication between processes on the same or different system. A variety of mechanisms employing some form of active or passive communication may facilitate the data exchange between processes on a same device, or on different devices. Examples illustrative of these inter-process communications include, but are not limited to, the implementation of a file, a signal, a socket, a message queue, a semaphore, a pipeline, shared memory, message passing, and a memory-mapped file. Other techniques may be used to share data between processes described herein. The processes may be part of the same or different application and may execute on the same or different computing systems.

A computing system performing one or more embodiments of this disclosure may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchscreen, a touchpad, a keyboard, a mouse, or any other input device 310 (FIG. 3) as the case may be. In response to selecting a particular item, information regarding the particular item may be obtained from the persistent 306 or non-persistent 304 storage by the computer processor 302. Upon selection of the item by the user, the contents of the obtained data regarding the particular item may be displayed on the user device in response to the user's selection.

By way of another example, a request to obtain data regarding the particular item may be sent to a server operably connected to the user device through a network such as the network 400 of FIG. 4. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

The computing system 300 of FIG. 3 may implement and/or be connected to a data repository. For example, in FIG. 4, any of the nodes 401-404 and/or the computer 406 may be connected to the data repository 410 through the network 400. One type of data repository is a database. A database is a collection of information configured for ease of data retrieval, modification, re-organization, and deletion. A Database Management System (DBMS) may be used. The DBMS is a software application that provides an interface for users to define, create, query, update, or administer databases.

The computing system 300 of FIG. 3 may be configured to include functionality for presenting raw and/or processed data, such as results of comparisons or other processing. For example, data may be presented through a user interface provided by a computing device. The user interface may include a GUI that displays information on a display device, such as the display 412, a computer monitor or a touchscreen on a handheld computer device, etc. The GUI may include various GUI widgets that organize what data is shown as well as how data is presented to a user. Furthermore, the GUI may present data directly to the user, e.g., data presented as actual data values through text or rendered by the computing device into a visual representation of the data, such as through visualizing a data model.

The present disclosure is not to be limited in scope by the specific embodiments described herein. Other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A computer-implemented method for knowledge base deduplication comprising:
providing a similarity graph having documents of a knowledge base D as nodes, with similarity edges between the nodes representing inter-document similarity exceeding a similarity threshold, and clustering the documents by similarity therebetween to provide a plurality of clusters within the similarity graph;
providing a set of safeguarded documents of the knowledge base; and,
for a cluster of the plurality of clusters, at least one of:
selecting a representative document; or
removing a non-representative, non-safeguarded document from the cluster.

2. The method of claim 1, wherein the similarity between documents u and v of the knowledge base D is determined based on a cosine similarity between vector-embedded representations xᵤ and xᵥ of the documents u and v respectively.

3. The method of claim 2, wherein the similarity between the documents u and v is further determined based on word n-gram shingling and a Jaccard index determined from n-gram shingles of the documents u and v.

4. The method of claim 3, wherein the similarity between the documents u and vis determined based on a weighted sum of the cosine similarity and the Jaccard index.

5. The method of claim 1, wherein the safeguarded documents set is provided based on at least one of:
a designation by a subject matter expert;
a designation by a machine learning model;
document metadata;
a policy; or
a document rank.

6. The method of claim 1, wherein the representative document is selected by a greedy dominating-set process.

7. The method of claim 6, wherein the greedy dominating-set process is seeded with the set of safeguarded documents.

8. The method of claim 1, wherein:
the similarity graph further comprises reference edges between documents u and v of the knowledge base D representing a direct reference from the document u to the document v; and
at least one of the selecting or removing takes into account the reference edges within the corresponding cluster.

9. The method of claim 1, further comprising:
for each cluster of the similarity graph, providing at least one of: a retain set R of retained documents; or a prune set P of removed documents; and
at least one of: combining the retain sets R of the clusters into an active documents index; or combining the prune sets P of the clusters into a pruned documents index.

10. The method of claim 1, wherein a record is made of a removal of each document from the knowledge base D in an auditable manner.

11. A computer-implemented system for knowledge base deduplication comprising:
a graph construction module for providing a similarity graph having documents of a knowledge base D as nodes, with similarity edges between the nodes representing inter-document similarity exceeding a similarity threshold, and for clustering the documents by similarity therebetween to provide a plurality of clusters within the similarity graph;
a safeguard set store for providing a set of safeguarded documents of the knowledge base; and
a similarity cluster formation module for operating on a cluster of the plurality of clusters by at least one of:
selecting a representative document; or
removing a non-representative, non-safeguarded document from the cluster.

12. The system of claim 11, wherein the similarity cluster formation module comprises a semantic similarity clustering module for determining the similarity between documents u and v of the knowledge base D based on a cosine similarity between vector-embedded representations xᵤ and xᵥ of the documents u and v respectively.

13. The system of claim 12, wherein the similarity cluster formation module is further configured to determine the similarity between the documents u and v based on word n-gram shingling and a Jaccard index determined from n-gram shingles of the documents u and v.

14. The system of claim 13, the similarity cluster formation module is further configured to determine the similarity between the documents u and v based on a weighted sum of the cosine similarity and the Jaccard index.

15. The system of claim 11, wherein the safeguarded documents set is provided by the safeguard set store based on at least one of:
a designation by a subject matter expert;
a designation by a machine learning model;
document metadata;
a policy; or
a document rank.

16. The system of claim 11, wherein the similarity cluster formation module comprises a pruning module configured for running a greedy dominating-set process seeded with the set of safeguarded documents for removing the non-representative, non-safeguarded document from the cluster.

17. The system of claim 11, wherein:
the similarity graph further comprises reference edges between documents u and v of the knowledge base D representing a direct reference from the document u to the document v; and
the similarity cluster formation module, when performing the at least one of selecting or removing, takes into account the reference edges within the corresponding cluster.

18. The system of claim 11, further comprising an aggregation module for providing, for each cluster of the similarity graph, at least one of: a retain set R of retained documents; or a prune set P of removed documents;
wherein the aggregation module is configured for at least one of: combining the retain sets R of the clusters into an active documents index; or combining the prune sets P of the clusters into a pruned documents index.

19. The system of claim 18, configured to provide a record of a removal of each document from the knowledge base D in an auditable manner.

20. A computer-readable medium storing instructions which, when executed by a processor, cause the processor to perform a method for knowledge base deduplication, the method comprising:
providing a similarity graph having documents of a knowledge base D as nodes, with similarity edges between the nodes representing inter-document similarity exceeding a similarity threshold, and clustering the documents by similarity therebetween to provide a plurality of clusters within the similarity graph;
providing a set of safeguarded documents of the knowledge base; and,
for a cluster of the plurality of clusters, at least one of:
selecting a representative document; or
removing a non-representative, non-safeguarded document from the cluster.
